(19) United States
(12) Patent Application Publication
(10) Pub. No.: US 2008/0060003 A1
(43) Pub. Date: Mar. 6, 2008

(54) METHODS AND SYSTEMS FOR SELF-SERVICE PROGRAMMING OF CONTENT AND ADVERTISING IN DIGITAL OUT-OF-HOME NETWORKS

(76) Inventors: Alex Nocifera, Manhattan Beach, CA (US); Ali Diab, Irvine, CA (US); Claude Ciocan, Placentia, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/849,115

(22) Filed: Aug. 31, 2007

Related U.S. Application Data
(60) Provisional application No. 60/824,428, filed on Sep. 1, 2006.

(51) Int. Cl. H04N 7/10

(52) U.S. Cl. 725/35

(57) ABSTRACT

A digital out-of-home network system for digital out-of-home applications and other types of advertising. A plurality of remote display units are included for video display of targeted advertising and digital media presentation. The media presentation systems and related methods may include advertising data servers that are preferably accessed wirelessly from a user work station. The work station may include a graphical user interface that allows the creation and scheduling of advertising content and assets to be displayed on remote display units located across selected regions. A user or advertiser may perform self-service operations such as creating and scheduling assets to be executed on selected windows or regions within any one or more video display units. The execution of assets and video clips on remote display units may be synchronized within a given unit or within a group of units residing in one or more locations. The information within a single or group of video display units may be coordinated over the user interface which can be accessible via a Web browser to provide significant flexibility in the display of information throughout the digital out-of-home network system(s).

### CROSS-REFERENCE TO RELATED APPLICATIONS

This application is based upon and claims the benefit of priority from U.S. Provisional Patent Application No. 60/824,428, filed Sep. 1, 2006, the entire contents of which are incorporated herein by reference. All publications and patent applications mentioned in this specification are herein incorporated by reference to the same extent as if each individual publication or patent application was specifically and individually indicated to be incorporated by reference.

### TECHNICAL FIELD

The present invention relates, generally, to communication networks, and in particular to a system and method for media content distribution for digital out-of-home networks and applications. More particularly, this invention relates to methods and systems for wireless programming of content and advertising over digital out-of-home networks.

### BACKGROUND OF THE INVENTION

Digital out-of-home networks and electronic signs are a dynamic media solution to help marketers target messages to a specific audience. Networked digital signage includes what some in the industry have termed narrowcasting in public spaces. This form of media communications allows advertising and other information to be delivered to narrow demographic groups at specific times in public venues. Examples of narrowcasting in public spaces include delivering pricing and promotional messages to shoppers in department stores or supermarkets, delivering appropriate advertising and news to commuters at airports, in train stations, on busses, or in elevators, or highlighting special offers to customers at retail settings. These and other examples of digital signage may be characterized generally into four segments: point of purchase, interactive, visual merchandising, and out-of-home advertising.

One of the biggest problems with current digital out-of-home networks is the investment of both financial resources and time to install the network infrastructure to support the underlying product. Most current digital signage technologies require the establishment of a LAN-based network. Setting up such a LAN-based network requires extensive capital for both the installation and maintenance of the network itself (cabling, routing, etc.) and the supporting server-based infrastructure. Even with the needed capital, many prime digital signage locations are not conducive to the installation of such items. Even wireless networks today mostly consist of 802.11 Networks, which still require the installation and maintenance of a LAN-based infrastructure to support the 802.11 Network.

It is also known to provide video advertising through out-of-home video display units. Video remains one of the most popular advertising medium in use today. In recent years, retailers and public space managers have brought in more video display systems for various advertising use. For example, retailers may use video displays to present current product offerings or sale information, while the public spaces can sell play or air time on such video displays to advertisers either national or local. One of the common goals is to expose a large numbers of consumers to the presentation of the advertisement and media content. While video is one of the most effective mediums because of its eye-catching, full color, high-resolution, full motion capability, there remain significant drawbacks in selecting this medium for advertising applications. Among other disadvantages, the production of video content can be rather expensive, and the production and distribution of new video material to one or more display units usually requires a high level of physical or manual intervention. Existing systems can distribute content to video display units in a variety of ways but with certain limitations. For example, a pre-recorded video loop can be played continuously on selected units and receive updated content via portable recording media such as a digital video disk (DVD). As new video loops are often produced by an advertisement production agency, multiple copies of the portable media have to be manufactured and physically distributed to each operator of video display unit at selected locations for playback. Alternatively, new material can be distributed or broadcast all at once although all displays may have to present the same material simultaneously and in the same manner. The addition of a single piece of new content to a presentation loop could furthermore require re-editing of the display media. It is often impractical and difficult to edit or re-sequence digital content once deployed to video display units. In the case of current systems where digital content is distributed and scheduled for viewing at any number of points of play, the administrative overhead to manually intervene and edit previously unscheduled content is time consuming and costly. An improved solution is needed to create, schedule and distribute content over a digital out-of-home networks.

### SUMMARY OF THE INVENTION

In accordance with various aspects of the present invention, a media and content distribution system and method are provided, wherein specific media and content, including advertising material, real time traffic, news, sports, weather, and financial stock and/or other like information is delivered via cellular or other wireless network technology to locally distributed display panels, such as large plasma and LCD screens, positioned in high traffic or viewing areas. In addition, an exemplary media and content distribution system can include a highly complex scheduling and rotating capability that enables multiple media files to display at multiple locations based on each individual display requirement for advertising, training, entertainment, and other purposes.

In accordance with an exemplary embodiment, a media and content distribution system comprises a Global Scheduling System (GSS) and a Regional Content Delivery System (RCDS) configured to communicate through a communications network such as the Internet. Content and media can suitably be delivered from the Regional Content Delivery System to a Remote Display Unit (RDU) through cellular or other wireless network. The Remote Display Unit can suitably “poll” the Regional Content Delivery System to receive data and information, and then proceed to store the data and information locally to suitably reduce network utilization. Accordingly, selected data, content and information can be provided at each Remote Display Unit depending on the requests or intentions of advertisers, data providers and/or local remote display users and viewers.

Another aspect of the invention provides digital media presentation systems having video display units that receive video images as clips in conjunction with scheduling information. The information received by the units includes the timing and/or sequence in which the video clips should be presented on the display units. Furthermore, the video display units can be divided into a plurality of windows or advertising regions. Within selected regions of the display units, desired video clips and scheduling information can be provided. In some embodiments of the invention, the scheduling information for video clips in each window or advertising window can be timed independently, or alternatively, the scheduling of video clips for a particular display unit can be synchronized in a selected manner.

In another embodiment of the invention, video clips and scheduling information are provided by one or more servers within a global scheduling system to selected display units residing in one or more locations. Each location may contain one or more video display units connected to a regional content delivery system, which in turn, are connected to the global scheduling system. The display units within a selected location may be optionally connected over a local area network, which may be addressed as a subnet of a larger network. Selected locations include retail stores, food and dining establishments and other locations that are frequented by consumers.

The advertising content and media systems provided in accordance with another aspect of the invention may comprise a self-service work station that allows an advertiser or other user to program content. The work station may be any computer capable of presenting a user interface or browser enabled device that allows a human operator to specify video information to be displayed and provide scheduling information for each display unit. The video information may be specified in one of multiple ways, such as graphics files, text to be displayed as a ticker, as an executable file or in any other suitable manner.

Other embodiments of the invention include, the server is an interconnection of servers and databases, including an interface server that manages interactions with human users, a media server that stores media and a database server that stores information about scheduling or displayed video. In a preferable embodiment, the server is located at a central location and connected over a wide area network to a local area network having a plurality of display units. The server may alternatively be connected to a plurality of display units over a local area network.

Another aspect of the invention relates to a series of one or more video display units adapted for displaying video information according to a predetermined schedule established over a self-service graphical user interface (GUI). The video display unit has a screen, a processor and a storage medium for storing video clips and schedule information. The processor is programmed to selected display video clips in accordance with the desired schedule information created by a user. A preferable embodiment of the invention includes display units that are programmed to generate a log of assets or video clips displayed. Each display unit may periodically write its log file to a server, where the information can be used for billing or other analysis.

It shall be further understood this invention includes methods and systems for programming content and advertising that are particularly suitable for digital out-of-home networks (“DOHNs”). DOHNs may be defined as networks comprised of electronic displays, e.g. cathode ray televisions (“CRTs”), liquid crystal displays (“LCDs”) or plasma television panels (“PTPs”) that are deployed in public venues, such as coffee shops, concert halls, shopping malls, sports stadiums, university campuses, etc. The DOHNs provided in accordance with the invention can be used to display targeted content and advertising to consumers that are visiting locales throughout selected regions wherein these systems are deployed. The systems and methods provided herein are an improvement over the content and advertising solutions today that are rely on displays that are programmed through a relatively time-intensive process by the administrator or owner of the DOHN (“DOHNadmin”). In a typical DOHN, the DOHNadmin receives advertising or content to be displayed on the DOHN from an advertiser on content creator (e.g. a film studio or local television station) in the form of a DVD or File Transfer Protocol (“FTP”) format. The DOHNadmin then compiles, edits and programs the content or advertising to be displayed on the DOHN through an administrator interface that controls all content on the DOHN. Instead, the solutions provided in accordance with the invention offers a way for advertisers and/or content creators to program their advertising or content directly, without the need for a DOHNadmin. This can be achieved through an Internet based self-service graphical user interfaces. These and other aspects of the invention provide improved digital signage and DOHN systems that take advantage of rapidly-developing technologies for networking, scheduling, content management, and electronic displays. When integrated effectively, these technologies can deliver advertising that can be sold and managed alone or complement traditional signs in stores, in buildings, along highways, or in other public places. It shall be understood that the concepts of the invention may be applied to known digital signage and out-of-home advertising systems such as those described in published patent application US 2006/0059511 filed on Sep. 14, 2005 entitled System and Method for Media Content Distribution, which is incorporated by reference herein in its entirety.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

The exemplary embodiments of the present invention will be described in connection with the appended drawing figures in which like numerals denote like elements.

FIG. 1 illustrates a diagram of an exemplary media content distribution system in accordance with an exemplary embodiment of the present invention;

FIGS. 2A and 2B illustrates a logic diagram of an exemplary method of RDU data transport in accordance with an exemplary embodiment of the present invention;

FIG. 3 illustrates a diagram of an exemplary cellular/wireless network in accordance with an exemplary embodiment of the present invention;

FIG. 4 illustrates an exemplary configuration of a screen layout for an RDU in accordance with an exemplary embodiment of the present invention;

FIG. 5 illustrates an exemplary screen image in accordance with an exemplary embodiment of the present invention; and

FIG. 6 illustrates a sample advertising layout in accordance with an exemplary embodiment of the present invention.

FIG. 7 illustrates an overview of the level of control available to an advertiser user over a self-service advertising programming user interface accessible via a Web browser.

FIGS. 8-11 illustrate a set of screenshots for a user interface that provides targeted advertising to customers of business establishments within a geographical area.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

The present invention may be described herein in terms of various components and processing steps. It should be appreciated that such components and steps may be realized by any number of hardware and software components configured to perform the specified functions. For example, the present invention may employ various electronic control devices, visual display devices, input terminals and the like, which may carry out a variety of functions under the control of one or more control systems, microprocessors or other control devices. In addition, the present invention may be practiced in any number of communication contexts and the exemplary embodiments relating to a system and method for media content distribution for digital out-of-home networks and applications as described herein are merely a few of the exemplary applications for the invention. For example, the principles, features and methods discussed may be applied to any communications application.

In accordance with various aspects of the present invention, a media and content distribution system and method are provided, wherein specific media and content, including advertising material, real time traffic, news, sports, weather, and financial stock and/or other like information is delivered via cellular or other wireless network technology to locally distributed display panels, such as large plasma and LCD screens, positioned in high traffic or viewing areas. In addition, a media and content distribution system can include a highly complex scheduling and rotating capability that enables multiple media files to display at multiple locations based on each individual display requirement for advertising, training, entertainment, and other purposes.

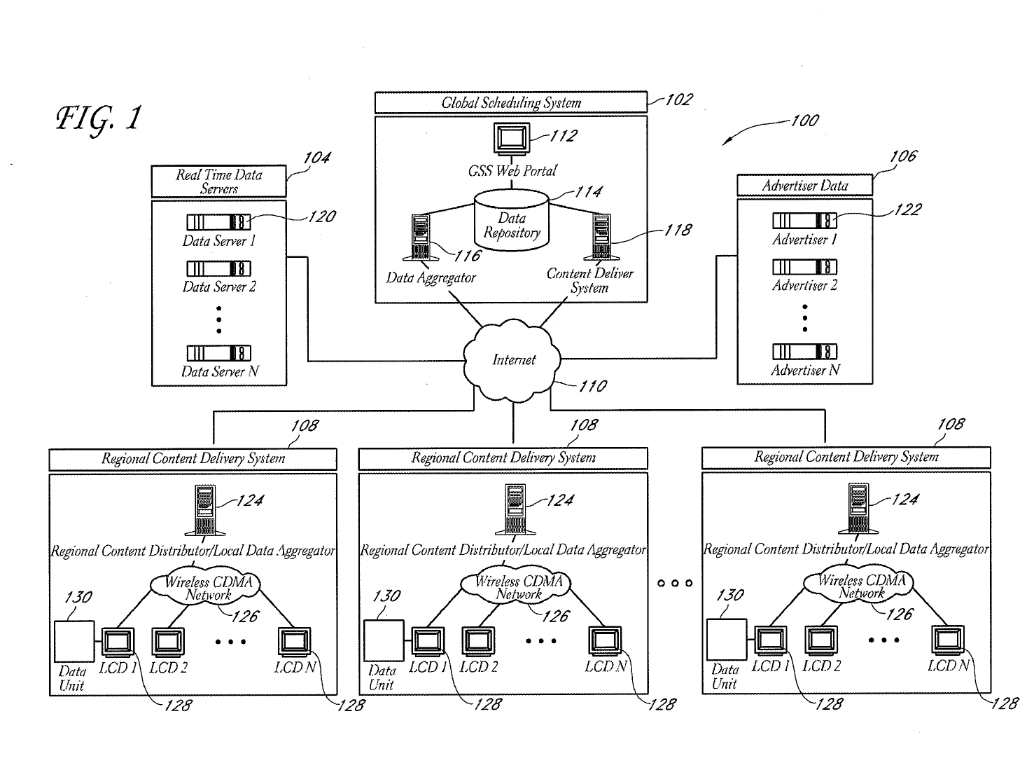

In accordance with an exemplary embodiment, with reference to FIG. 1, an exemplary media and content distribution system 100 comprises a Global Scheduling System (GSS) 102 and one or more Regional Content Delivery Systems (RCDS) 108 configured to communicate through a communications network such as the Internet network 110. Internet network 110 can comprise any configuration of network for allowing communications between global scheduling system 102 and RCDS 108.

Global scheduling system 102 is configured for collection of data and content and to provide such data and content to Regional Content Delivery Systems 108. In accordance with an exemplary embodiment, global scheduling system 102 comprises a data aggregator 116 to collect real time data and graphical content from disparate systems, a data repository 114 to store all of the content, a web portal 112 to manage and schedule the content, and a content delivery system 118 to push out the content and scheduling information to a selected regional content delivery system 108.

Data aggregator 116 communicates with numerous real time content providers and periodically updates data repository 114 with current data. The data supplied by the different content providers will vary and therefore the data aggregator 116 will normalize the data and store it in a common format. Such data and advertising content can be acquired from various sources, such as from real time servers 104 and/or advertising data sources 106. Data aggregator 116 can also gather and store the media files necessary to display the content.

Web portal 112 is configured to authorize users to schedule real time media delivery to individual remote display units (RDUs) 128. Content can be altered and rescheduled easily and a complete log of historical data can be stored in data repository 114.

In addition to storing digital content, data repository 114 may also serve as a scheduling database. It stores information about RDUs 128, and stores playlists for each one. Each playlist identifies a schedule of display content or assets processed by an RDU 128. Generally, the display content is any object that may be executed by the RDU 128. The display screen on each RDU may be segmented into multiple windows or regions, with a separate playlist for each window.

In a preferable embodiment of the invention, the playlist is represented by an XML document. In this embodiment, display content may be any object that can be accessed from an XML document, such as a PERL script or a J2EE web application with an XML interface. Such display content may impact the rest of the displays on an RDU 128. However, such display content need not impact the other information displayed visually by the RDU 128. Such display content could, for example, cause the RDU to perform a self test, provide information to other RDUs, provide information to the GSS 102 or perform any other automated task. The data repository may store more than one schedule for each RDU.

Content delivery system 118 is configured to periodically poll data repository 114 for changes in content and schedules and then transmit the appropriate data to the selected regional content delivery systems 108.

Regional Content Delivery Systems (RCDSs) 108 are configured to serve as an intermediary between the client-side devices and global scheduling system 102. In accordance with an exemplary embodiment, each RCDS 108 comprises a regional content distributor/local data aggregator 124 configured to communicate through a cellular or wireless network 126 to one or more client side devices 128, e.g., one or more RDUs.

Regional Content Delivery System 108 is programmed to “pull” data from real-time disparate sources, including advertising data and/or real-time traffic, news, sports, weather, and/or financial information. In addition, RCDS 108 can also be configured to retrieve local real time data and local advertising media based on scheduling information from the global scheduling system 102. RCDS 108 can regularly monitor each client device for vital statistics and returns stats to data repository 114 of global scheduling system 102.

Additionally, the global scheduling system 102 may transmit the required display contents to the RDUs 128 so that they are available to the RDUs to execute at the scheduled times. Various methods may be employed to determine when the display contents should be provided to the RDUs 128. In some embodiments, the GSS 102 may provide a server that compares the display contents stored for each RDU 128 with upcoming events scheduled for that unit. From this comparison, the GSS 102 can determine when the RDU 128 will require new assets. The GSS 102 can therefore provide the new display contents before that time. However, the GSS 102 can also compare the memory utilization of the display contents stored in the RDU 128 to the available memory in the RDU. It does not provide new resources until after display contents that would have to be deleted to make room for the new display contents are no longer needed.

RCDS 108 may also deliver data gathered from client devices 128 at a public venue, indicating what display content was displayed to the data repository 114. For example, RDUs 128 may display advertisements for which the retailer charges a royalty to display. The RDUs 128 send information on actual content displayed to the GSS 102 which would then create a record in the data repository 114. Records of content displayed may be provided to GSS 102 directly or may be collected by RCDS 108 where they can be periodically pushed to the GSS 102 or periodically read by the GSS 102. As an example, records of actual content displayed may be used to compute royalties due the retailer for displaying advertisements in a retail location or to compute royalties owed to the content providers when display contents are executed.

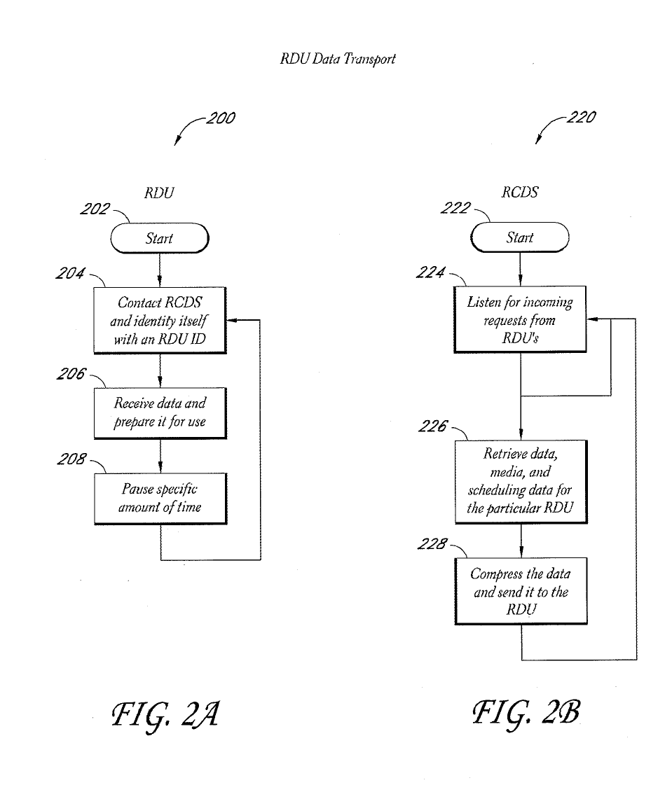

The data and content from an RCDS 108 can be provided in various manners to Remote Display Units (RDUs). For example, with reference to FIGS. 2A and 2B, at start (202) an RDU is configured to contact or “poll” an RCDS 108 and identify the certain RDU through a unique identification (204) over a wireless connection or network. The data can be transmitted via a cellular or other wireless network, such as a CDMA wireless connection, GSM, EDGE, or EVDO or other like networks, to the specific RDU. It shall be understood that communications between the RDUs, RCDSs, the GSS and servers related thereto can be achieved over a variety of wireless networks that provide wireless broadband Internet service including but not limited to satellite, cellular, Wi-Fi and WiMax or other IEEE 802.11 standard implemented wireless networks.

An exemplary RDU can suitably receive data and prepare for use and display for users (206). In addition, an exemplary RDU can then proceed to store the data and information locally to suitably reduce network utilization. RDU can then suitably again contact an RCDS 108 for additional or update information, such as after a pause (208). Concurrently, an exemplary RCDS can suitably start communications and data delivery (222) by listening for incoming requests from RDUs (224), and then suitably retrieve data, media and other scheduling data for the requesting RDU (226). Such data can then be transferred in various formats to the appropriate RDU, e.g., the data can be suitably compressed before sending to the RDU (228), i.e., for receipt of date and preparation for use (206). Accordingly, selected data, content and information can be provided at each RDU depending on the requests or intentions of advertisers, data providers and/or local remote display users and viewers.

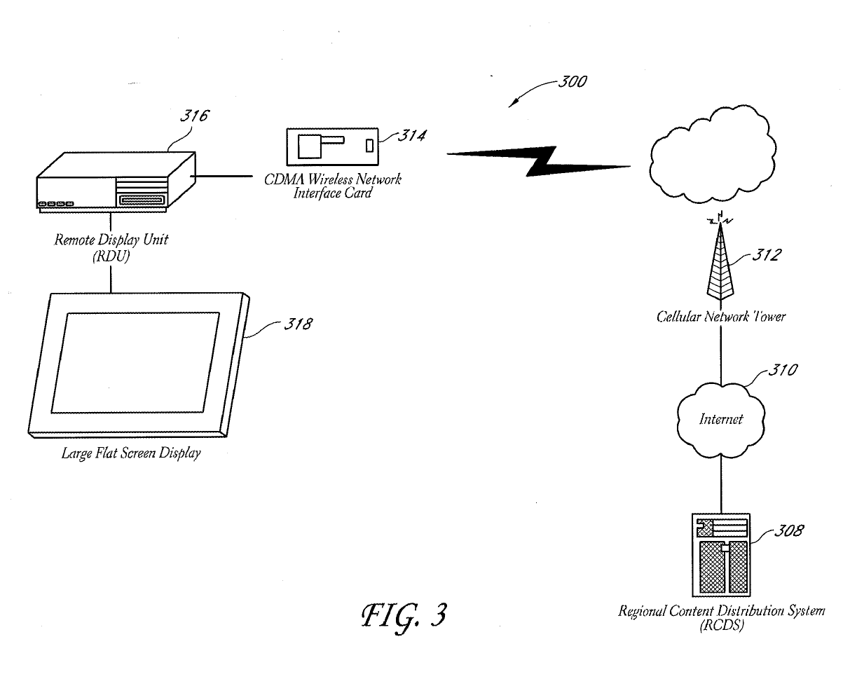

Content, data and media can suitably be delivered from the Regional Content Delivery System (RCDS) to a Remote Display Unit (RDU) through various configurations of cellular or other wireless networks. For example, with reference to FIG. 3, in accordance with an exemplary embodiment, a cellular communications network 300 can comprise an RCDS 308 coupled to a cellular network tower 312, such as through an Internet network 310 or any other suitable network. Cellular network tower 312 can comprise any system or device for facilitating cellular or wireless communications between devices.

An exemplary RDU 316 can comprise various configurations, including one or more microprocessors, memory devices or other computer components. To transmit requests and receive data, RDU 316 can suitably comprise a cellular network interface card 314. Any information, data or other content can be suitably displayed through a variety of devices, such as for example, a large flat screen display 318, or any other display device. The content displayed on the display device 318 may be generated by the processor within the RDU 316 executing the data received from an RCDS 308.

In addition, each RDU 316 can continue to drive local remote display 318 with the last known media, real time data, and schedule, even when the cellular network becomes unavailable. RDU 316 can also perform health checks at regular intervals and attempt to reconnect to the cellular network as soon as it becomes available.

Also, one of the RDUs 316 may act as a controller unit and others may act as controlled units. The controller unit may contain copies of the data and content to be executed. As it executes display content according to its playlist, the controller unit sends commands to controlled units causing them to execute the same display content simultaneously. It is not necessary that controlled unit display the same information as controller unit. In some embodiments, controller unit may execute multiple schedules. One schedule may control the information displayed on the display screen 318 associated with controller unit. A second schedule, which may be synchronized with the first schedule, may specify information to be provided to controlled unit.

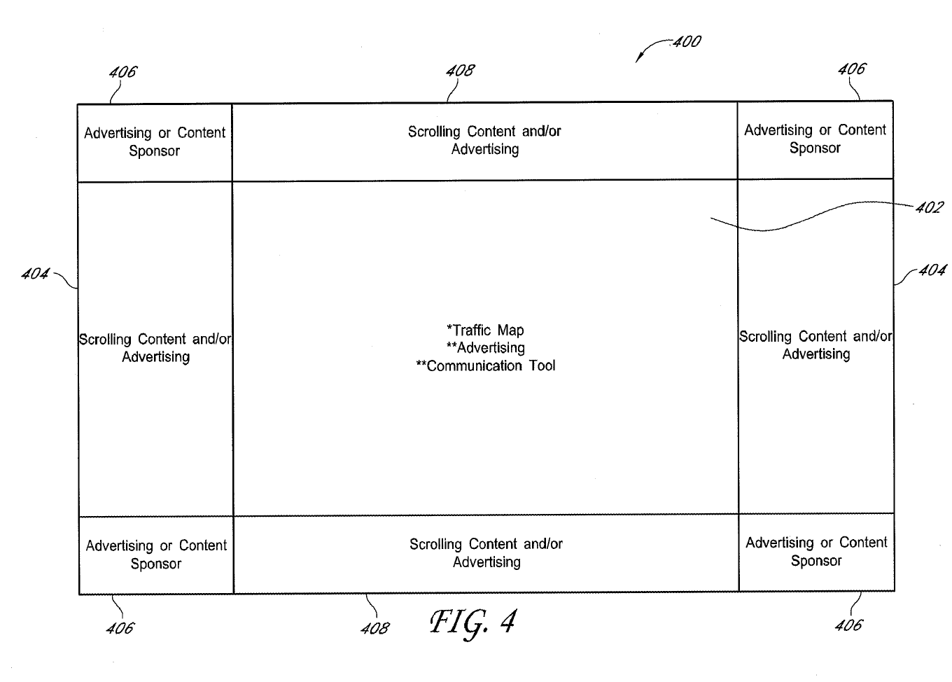

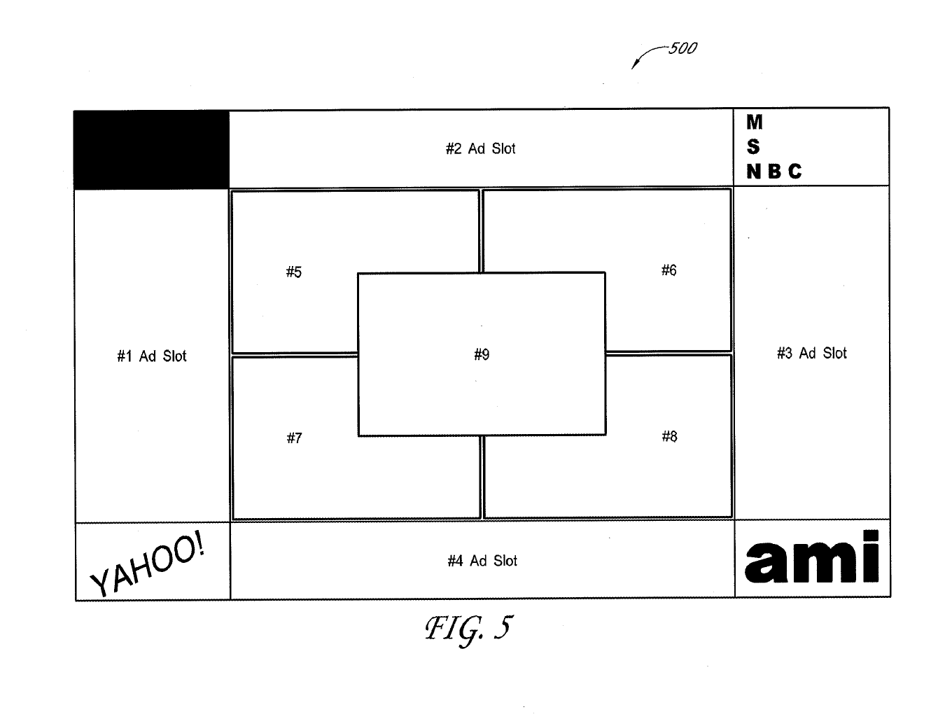

The data, content and other information can be suitably displayed by display device 318 in various formats. For example, with reference to FIG. 4, an exemplary screen layout 400 can comprise a main display area 402 that includes desired data, such as traffic, communications, advertising or any other data or content, one or more scrolling content and/or advertising regions 404 and 408, and one or more stationary advertising or content sponsor regions 406. Display area 402 can comprise a single region or two or more regions. For example, with reference to FIG. 5, a display area can comprise slot #'s 5, 6, 7, 8 and/or 9. Information in each region may be coordinated to provide significant flexibility in the display of information through the RDU.

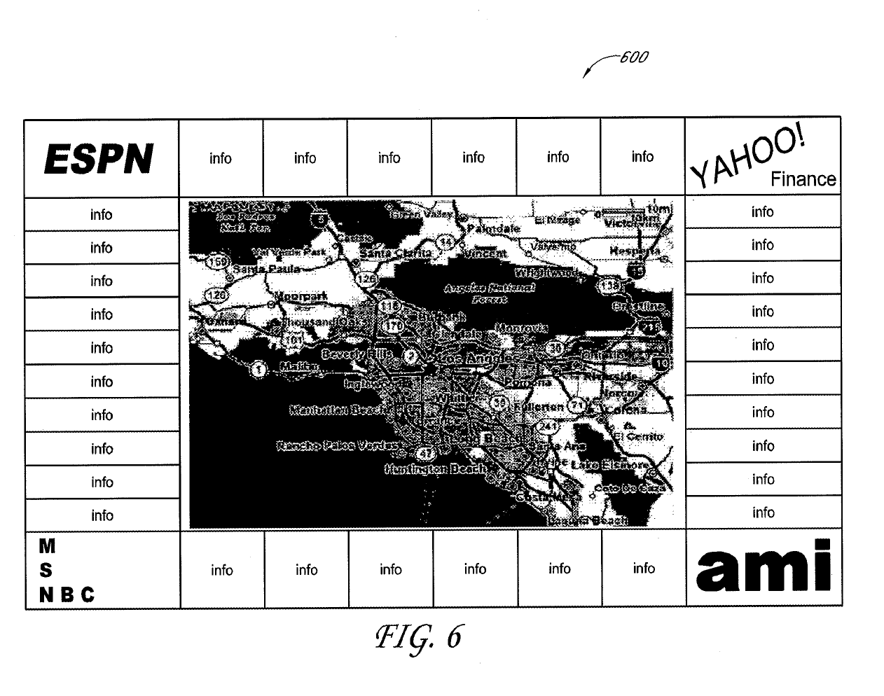

Regions 404, 406 and 408 can be suitably interchanged in any manner, can include scrolling, dynamic or static information, and can comprise various dimensions around or within display area 402. For example, with reference to FIG. 5, an exemplary screen layout 500 can comprise one or more advertising regions, e.g., #1, 2, 3 or 4 ad slots. In accordance with a further exemplary embodiment, a display screen can comprise a variety of data, such as that illustrated with reference to FIG. 6.

The playlists for display content in each of the regions may be synchronized so that the content in the separate regions within one or more RDUs are synchronized. A simple way to synchronize the execution of display content is to create playlists that execute in the same amount of time. For example, if a video clip displayed in main display area 402 will execute for 30 seconds, the playlist for scrolling content and/or advertising window 408 may specify for an advertisement to be synchronized to the video being displayed for 30 seconds. Multiple display contents may also be synchronized. For example, if a video clip displayed in main display area executes in 30 seconds, the playlist of scrolling content/advertising region could specify a series of display content that collectively execute in 30 seconds. As a specific example, the playlist for content/advertising region could have a still image displayed for 10 seconds, an HTML file for 15 seconds, followed by a Flash animation for 5 seconds.

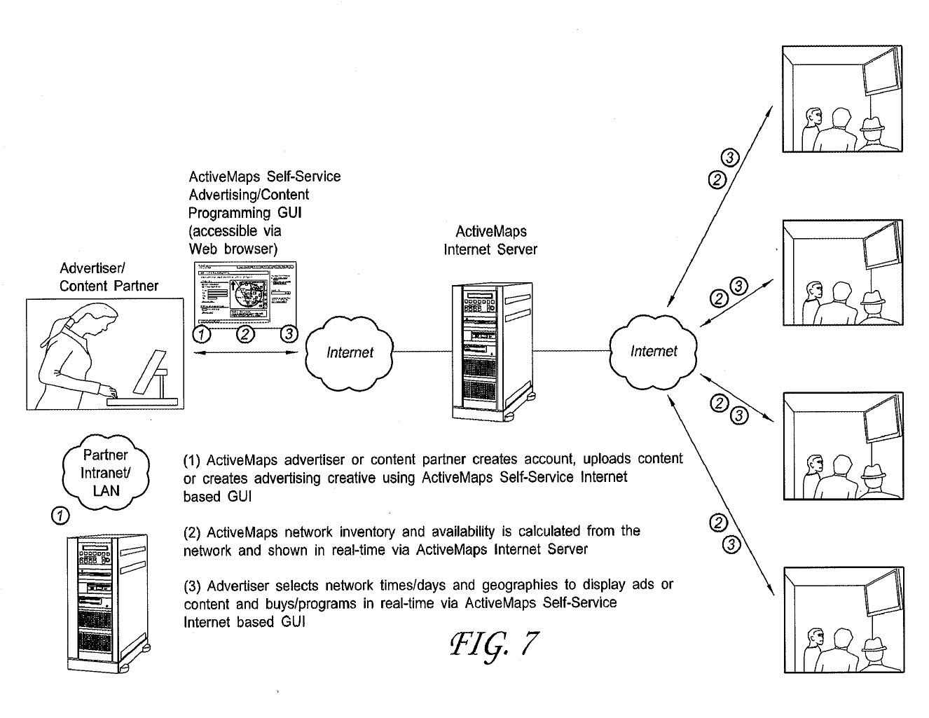

According to a preferable embodiment of the invention, with reference to FIG. 7, an exemplary digital out-of-home network (“DOHN”) comprises a DOHN server in communication with operator terminals. The DOHN server can be connected to one or more operator terminals over a communications network such as the Internet. An operator terminal may consist of various client computers such as a conventional desktop PC, a computer workstation, or other suitable operator interface devices and may be located in any convenient place. An operator terminal provides a self-service, Internet-based content programming GUI to allow an advertiser or content provider to enter programs or data into DOHN server. The operator terminal may provide a content programming user interface allowing a content provider to directly schedule and upload content to be displayed on each of the RDUs. RDUs are connected to the DOHN server over a communication network such as the Internet as well, and may be wirelessly connected to the DOHN server and other scheduling/content delivery systems described elsewhere herein. It shall be understood that communications between the RDUs, RCDSs, the GSS and servers related thereto can be achieved over a variety of wireless networks that provide wireless broadband Internet service including but not limited to satellite Internet, cellular Internet, Wi-Fi and WiMax or other IEEE 802.11 standard implemented wireless networks. Preferably, a form of encryption is used to ensure that unintended third parties do not gain access to the RDUs. For example, communications through the Internet may be by way of an encrypted tunnel (PPTP). It shall be understood however that any suitable security mechanism may be used.

A user such as an advertiser or content provider can enter commands and content data to the DOHN server via a Web browser on operator terminal or work station. The operator terminal allows a content provider to upload display content or specify scheduling of display content for RDUs at one or more public venues. In a preferable embodiment of the invention, each of the RDUs contains multiple display windows, each displaying a different type of data. In this embodiment, content programming interface allows different content providers in different locations to specify the contents of different windows.

Additionally, operator terminal may allow a content provider to retrieve status information from the RDUs in one or more public venue. Status information may, for example, be in the form of log files recording display content executed by those RDUs. The operator terminal may display this information to a content provider or may process one or more reports for the content provider. Such information does not need to be provided directly to a human entity. It may, for example, be used in an automated billing system to generate bills to advertisers and other content providers whose content was displayed on the RDUs within a retail location. Alternatively, status information may be used to generate royalty payment reports needed to pay royalties to content providers whose content was displayed in the display units within a retail location.

A content programming user interface may be presented to a content provider such as an advertiser through any suitable operator interface device. The content programming interface may include control constructs as are traditionally used in graphical user interfaces for personal computers. These controls allow a content provider to associate specific display content with a specific display area for a specific group of RDUs. The content programming interface may include a menu bar such as those incorporated into Microsoft Windows operating systems. A menu bar provides a means for a content provider to access any of the primary functions of the user interface. A list window displays and folders may display information in a hierarchical fashion. The controls can determine which type of information is displayed in list window. In an alternative embodiment of the invention, the controls may be selected such that playlist schedules are displayed in list window for viewing and editing.

In a preferable embodiment of the invention where the RDU screen is divided into at least three different display regions or windows, a number of playlist schedules can be organized into three groups: those for a main display area, those for a scrolling content/advertising area, and those for an advertising or content sponsor area. Multiple playlist schedules may be created within each type. For example, a content provider may program a playlist schedule for current play and another program schedule to start on a specified date and time under the category of scrolling content/advertiser area. A content provider may wish to create multiple playlist schedules to allow different playlists to be specified for different RDUs or groups of RDUs. Alternatively, multiple playlists may allow different playlists to be specified for the same groups of devices at different times. Multiple schedules may be provided to allow rapid changes of the display content scheduled to be displayed at groups of RDUs.

Each playlist schedule provides a mapping between RDUs and specific playlists. Playlist schedules may be created, but are not effective until a content provider invokes the command to transmit, which causes the DOHN server to send playlists to each RDU for which a playlist is specified. In a contemplated embodiment, only “new” playlists will be transmitted. In this way, playlists are only transmitted when they are different from the playlist previously transmitted.

A content provider may specify the relationship between device groups and specific playlists needed to create a playlist schedule. The playlist schedule may be located in a drill down window. In an example, a window may show RDU groups are identified under different names and categories. Each RDU group has associated with it a control that allows further detail in the hierarchy to be revealed or hidden. Highlighting a playlist in this window causes details of that playlist to appear in the window below.

Each playlist may consist of a series of content for display. Accordingly, when the playlist schedule for current play is published, the RDUs in the device group identified will receive a playlist that causes the processor associated with those RDUs to first display within the scrolling content/advertising area an image corresponding to the first display content listed in the playlist. The processor within the RDU will display this image followed by the information generated by the second display content listed in the playlist and cycle through all of the display content in the playlist. The display content may be of different formats. For example, this second display content may be web application that retrieves information about bus schedules or arriving in departing buses from a web server and display that information in scrolling content/advertising area.

The content programming interfaces provided in accordance with the invention allow a content provider to change the playlist, device groups, or playlist schedule by using the controls on the GUI. For example, a window includes a control that allows a content provider to create or add an asset or display content to an existing or new playlist. A user can initiate a wizard program that allows display content to be added to the specified playlist. A wizard window may, for example, appear superimposed on the content programming interface. As is known in the art, a wizard is a program that walks a user through series of steps required to perform a specific function. These self-service or self-help types of programs are provided in accordance with this aspect of the invention to give users greater flexible control over media presentation, scheduling and advertising. The wizard window could give the content provider a choice of uploading new display content from a local or remote source or selecting existing display content stored in a local or system database. Once the content provider makes a choice, the content provider may move to the next step in the process controlled by the window by operating the control.

The next step in the process may include adding display content to a playlist when the content provider has elected to add existing display content. In wizard window, a content provider may specify a display content format. Specifying a display content format causes a list of all display content of that format already created to appear in a list window. The content provider may highlight in list window one of the display content. When particular content is selected, a content provider may then move to the next step in the wizard.

When a content provider indicates through wizard window that the content provider wishes to upload new display content, the wizard window would guide the content provider through identifying the display content and providing it with a name such that it could be referenced by the display system. As described above, display content may be digital files. Identifying the display content may include specifying the location of the digital file so that it later may be accessed or loaded into DOHN server. Other information on the display content may also be gathered. For example, the owner of the display content may be recorded and stored in a database such as the scheduling database to facilitate payment of royalties.

The wizard window also allows the content provider to change the order of the display content in the playlist. By highlighting an item in list window and operating the controls, a content provider may move a particular entry up or down in the playlist. Upon completion of the ordering of the playlist through wizard window, the content provider may select to finish the wizard, returning to the content programming interface.

When the content provider has completed changes with the playlist, the content provider may elect to apply those changes by using an application control. When the application control is operated, each playlist schedule is updated to include the new playlist. When that playlist schedule is next transmitted, the new playlist will be provided to each RDU scheduled to execute that playlist.

Other controls in content programming interface allow the content provider to perform other functions that specify the scheduling of display content on devices throughout the RDU. For example, a control may allow a content provider to highlight display content in a playlist appearing in drill down window and remove that content from the playlist.

Similar wizards and control functions allow a content provider to specify information about RDUs, RDU groups or display content. For example, by activating control, content programming interface would reconfigure to display information on RDUs in a list window. Information may be sorted by RDU group, RDU device type, RDU location or in any convenient way. Content programming interface may contain controls (not shown) that specify the criteria for grouping RDUs on the window.

When list window is configured to RDU devices organized by RDU groups, selecting a group from list window may cause a list of RDUs in that group to appear in a drill down window. Such a drill down window may include controls corresponding to the control to add or remove display content. Such controls in connection with a RDU group drill down window would allow RDUs to be added or removed to each RDU group. Likewise, selecting the add RDU device control may invoke a wizard walking the content provider through the steps of selecting an RDU. Such a wizard may walk the content provider through the steps of identifying an RDU device to the group.

Other wizard screens may guide a content provider through the process of identifying a new RDU device to the system. For example, when a content provider is entering a new RDU, wizard screen may contain fields to collect information about the RDU. Such information may include RDU name, the type of RDU device, the size of the RDU (in pixels) and a location for the RDU. Each RDU may be accessed through an IP address. Wizard screen may also have a function to determine an IP address for the RDU.

Likewise, display content may be managed through the content programming interface. For example, activating control may cause a list of display content to appear in list window. Display content may be grouped by content type, display content owner or in any convenient manner. Wizard screens may also allow the uploading of new display content. As described above, display content may be stored as digital files that may be executed and the wizard may guide the content provider through the process of identifying the file to use as display content. It shall be understood that other user interface features and automated programs besides wizard programs can be selected herein to select and display playlists herein.

The content programming interface as discussed is one example of the manner in which display content may be scheduled on a plurality of RDUs throughout the content distribution system. Any suitable mechanism may be used. For example, an interface window may optionally be used to allow a user to “group” display content. When a display content that has been “grouped” with other display content is executed, the RDU executing that content also executes any grouped display content in other display windows.

One of the display content will be dominant because the scheduling of that display content will drive the execution of the grouped content. A number of fields can be provided for information about the dominant display content, such as a field for the length of the content. A variety of controls may allow a content provider to indicate the layout of the RDU on which the dominant display content will be displayed and the display area in which the dominant display content is to be displayed when the grouping applies. A list box may be a user to select the layout and to select the desired display areas.

The user interface may further include a window with multiple tabbed areas that correspond to one of the display areas in the layout indicated in list box that might be synchronized to the display area selected in dropdown list box. Tabbed area contains a list of display content to be displayed in one of the display areas when dominant display content is displayed in the main display area. In one example, list may specify what other specified display content should play, in what order, when that specific dominant display content is displayed in the main display area.

A group of controls allows a content provider to perform such functions as adding display content to list, deleting display content from the list, changing the order of display content in the list or otherwise altering properties of the display content in the list. List may be thought of as a “grouped playlist” and any operations that are performed on a playlist may optionally be performed on the list. Entries in each tabbed area may create grouped playlists for each of the display areas of the RDU.

When the grouping is applied, the grouping information is stored in a scheduling database. The grouping information may then be provided to RDUs. Grouping information may be provided in any suitable manner. For example, grouping information may be provided using the same communication channels as are used to publish playlists to RDUs. Grouping information may be provided to all RDUs when transmitted or may be provided selectively only to those RDU devices receiving playlists in which the dominant display content appears.

When the dominant display content is executed in the specified window, the RDU then executes any grouped playlists for the other display areas. If a display area is already executing a playlist when the dominant display content begins to execute, that playlist is interrupted. When execution of the dominant display content is finished, the RDU resumes execution of the playlists for each display area. The playlists may resume at the point where they were interrupted or may resume at the point they would have reached had they not been interrupted to execute the grouped playlist.

In this way, synchronization may be readily provided within display windows of an RDU. This concept need not be limited to grouping of display content executed on the same RDU. The grouping concept may be extended to grouping of display content executed on different RDUs. As described above, the content distribution system may be constructed such that RDUs are connected to a network, allowing messages to be transmitted between RDUs. When dominant display content is executed on one RDU, it may send a message to other RDUs, containing grouped display windows, to execute grouped display content in those windows.

In one embodiment, scheduling is performed on “segments.” A segment is a group of playlists specifying the actions of an RDU or a group of RDUs at one time. For example, a segment for RDUs having three video windows may consist of three playlists, one for each video window. A content provider input screens within a GUI can facilitate the grouping of playlists into segments specified in any suitable manner.

The content programming interface herein may further provide a graphical representation of time slots in which segments may be scheduled. Fields allow a content provider to specify a specific day. When a day is selected in field, a timeslot schedule for the selected day is displayed in another field. This field may be segmented into multiple time slots. When segments are specified to be executed in certain time slots, they are said to create a content block. The content programming interface includes a group of controls that may be used to add or delete content blocks. The group of controls within group may also be used to modify the parameters specified for any content block.

When a control is activated to add or modify a content block, a separate user interface may be presented. The separate interface contains a window in which segments available for programming are displayed. Segments may be displayed hierarchically or in any other suitable fashion. The controls can be added to allow a content provider to select or de-select segments for inclusion in the content block. Selected segments may be identified to the content provider in any convenient means, such as by listing them in a window.

Furthermore, the separate interface includes a group of controls to allow the content provider to specify the start and end of the content block. Any suitable control interface may be used. For example, drop down list boxes may be provided to allow a content provider to select the start time of the content block. The content block may end once the segments selected for the content block are executed. Alternatively, controls may be provided to allow the user to specify an end time to the content block. In this scenario, display units may be programmed to respond to situations in which the segments in the content block either are executed before the specified ending time or are still executing when the specified ending time is reached, such as by looping through the scheduled segments but interrupting execution of the segments at the specified ending time. As a further alternative, the system may be capable of determining the end of a content block in either fashion and the content provider could be given the option to specify the ending time of the content block or to allow the system to determine the end of the content block based on the length of the segments programmed into that content block.

The user interfaces provided herein may also contain a group of recurrence controls. Recurrence controls may create multiple copies of the same content blocks at a specified frequency. For example, the recurrence controls may specify recurrence at a frequency that may be daily, weekly, month, etc. The separate interface may also include range controls that allow a content provider to specify the length of time for which the recurrences should be scheduled. The range may be specified based on an ending date or may be specified based on some number of recurrences. Regardless of the specific manner used to specify the range, when a content block is scheduled with a recurrence, the DOHN server providing the content programming interface may enter in the schedule multiple copies of the content block at the recurrence frequency throughout the recurrence range. In addition, the interfaces can further include a group of controls that specify actions for each recurrence of the content block. For example, one control in the group may specify that the exact same content is executed for each recurrence. Alternatively, a control may specify that the system check for updates to each display content in the content block for each recurrence. Such a feature may be useful, for example, when display contents are generated automatically.

Additionally, the user interfaces herein may also include a priority field. For example, field may be a dropdown list box, allowing a finite number of ordered choices. As described elsewhere herein, the content provider can be provided with multiple methods to specify the display contents to be executed in each display area in each RDU. Whenever multiple display contents are specified for the same display area of the same RDU, the RDU will execute the highest priority. Priority may be implied. For example, it was described above that grouped display content interrupts scheduled display content. Thus, grouped display content has an implied priority higher than scheduled display content. However, the system may allow a content provider to specify a priority of display contents to control whether one display content interrupts another. Here, a priority can be specified for the content block and all display contents executed within the content block share that priority, but other suitable methods for specifying priority may be used, if desired.

The user interfaces provided in accordance with the invention may further include a group of controls that specify the behavior of the RDU when the content block interrupts execution of another playlist. Options may include resuming the prior playlist at the point of interruption or resuming the playlist at the point at which it would have been playing had it not been interrupted intentionally or accidentally due to a disruption in communication or power etc.

Another aspect of the invention provides a user interface designed for an advertiser that facilitates the targeting of advertisements to particulars groups of customers. An advertiser from a remote location over the Internet, preferably from a Web browser, can access an advertisement center to launch a targeted advertising campaign. After the advertiser creates an account and logs-in over a self-service user interface as described elsewhere herein, a series of screens can be presented offering a series of choices in the manner selected advertising or content is displayed at remote locations. This aspect of the invention offers a significant improvement over way a typical DOHN today in which advertising is untargeted. Unlike television or radio broadcast networks, each display in a DOHN provided in accordance with invention do not necessarily receive and display the same advertising and content signal. Moreover, advertising and content can be targeted from a remote location to a particular audience as opposed to accomplishing this in the typical manual fashion at the local signal or display level (e.g. a local radio or TV station that manually insert ads into an otherwise national broadcast).

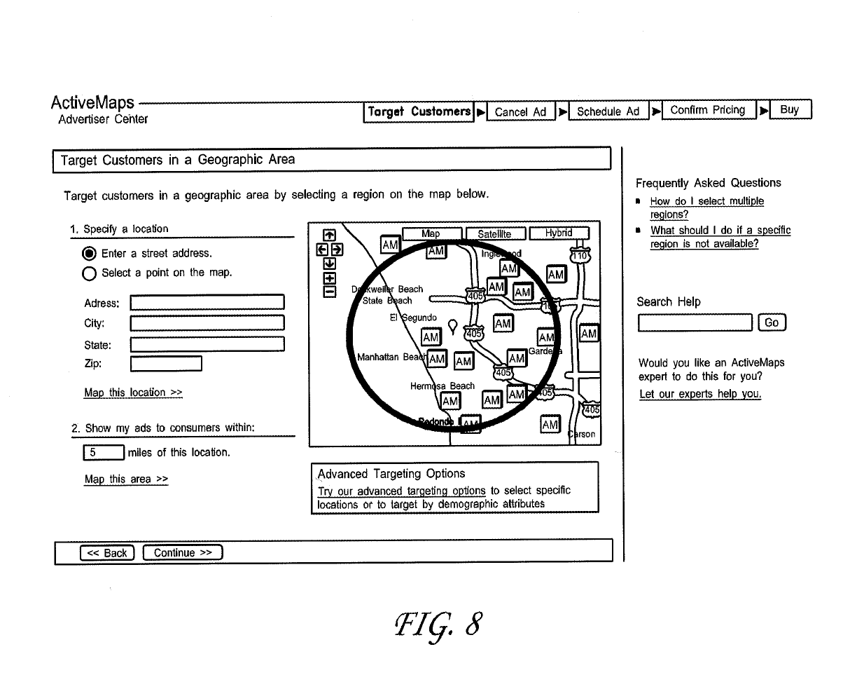

The screenshots depicted in FIGS. 8-10 describe an embodiment of the invention that provides a user interface for an advertiser center system. The user interface graphically depicts the targeting capabilities within DOHNs such as those shown in the figures. The targeting capabilities of the system can be carried out over a wireless network as described elsewhere herein and can be based on a selected number of factors. Methods are provided for customizing the programming of advertising and content in DOHNs based on a number of targeting factors, including but not limited to the following: (1) the specific ID number of an RDU, a panel or other display device (e.g. device ID #12345); (2) the geographic location of each display device (e.g. device located at 123 Main Street, Anytown, State, USA); (3) the demographic characteristics of an audience that typically views or is exposed to the display device (e.g. females between the ages of 22 and 34, men with annual household incomes of greater than $75,000); and (4) the time of day and time of week in which the advertising or content is displayed (e.g. only between the hours of 8 am and 12 am on Mondays, Tuesdays, Wednesdays and Thursdays). A preferable method according to the invention provides targeting advertising and content based on the grouping of display devices based on any of the targeting factors such as those enumerated above (1-4). For example, an advertiser may be able to select one or more groups of displays by device ID, location, the demographic characteristics or time of day/time of week characteristics that could be targeted. In an embodiment of the invention, the display devices for a particular retailer (Starbucks Coffee) may be assigned a series of ID numbers (SB 123, SB 124, SB 125 etc) for its stores located throughout a local, statewide or wider region. As a result, targeted advertising can be delivered to consumers beyond just the physical location of display devices but through a retail chain having stores spread across a wide area. Advertisements may be also displayed at all display devices within a selected zip code or within a defined mile radius of a certain location. It shall be understood that the invention is not limited to the targeting factors expressly set forth above but includes others also known in the field which be selected herein

According to a preferable embodiment of the invention, the step of targeting selected advertising may be included as just one step in an overall self-service process of delivering advertisements over a DOHN. An advertiser or user may create an account and establish a user-ID and password as is known with other online accounts. Methods and systems are provided herein that allow advertisers to deliver content and advertisements by themselves without relying on or paying a third party. These self-service processes may comprise one or more of the following steps of: targeting customers according to selected parameters (who/where); creating or selecting advertisements to be displayed (what); scheduling the advertising for display (when); confirming the pricing for the desired advertising (how much); and buying the desired advertising as selected by the user in real-time over an Internet connection, preferably through a Web browser such as Microsoft Internet Explorer.

When targeting customers within a geographic area, as shown in FIG. 8, a user or advertiser can select a region in a number of different ways through an interface provided in accordance with this aspect of the invention. The user may specify a location by street address and zip code that can be entered in displayed fields. Alternatively, a pictorial representation or map of a surrounding geographic region can be displayed for the location with navigational arrows such as those provided by Google Map or Mapquest services. The map may preferably identify locations of display units as shown that are installed at various sites and cities within the selected region (AM logos superimposed on map). Each display device may be pre-assigned a specific ID number for targeting purposes. Starting from a selected initial location, advertisements may be targeted within a defined range or distance (number of miles) from that location. Accordingly, each of the display devices falling within the specified range provided can be included within a group of units that will display the desired advertising selected by the user or advertiser.

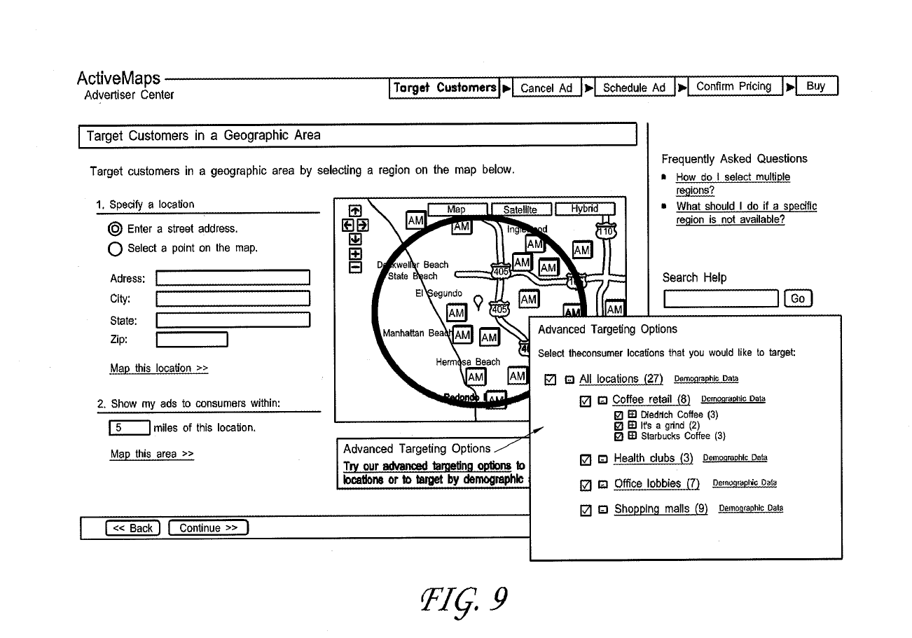

A preferable embodiment of the invention provides a user interface with advanced targeting options as illustrated in FIG. 9. When the user selects the advanced targeting option, a pop-up window may be displayed that offers greater targeting capabilities for delivering advertisements and content. For example, any currently available consumer locations may be displayed allowing the user to designate which kinds of retailers or retail stores can be targeted (Coffee retail, Health Clubs, Office Lobbies, Shopping Malls), or optionally, all locations within the DOHN(s) could be targeted (All locations). Each consumer location option can be displayed with a box that is checked-off when clicked-on by a mouse or other input device. The number of display devices or locations within a DOHN may be provided parenthetically (Coffee retail (8)) and additional demographic data for the particular consumer location may be displayed to the user by clicking-on an optional link (Demographic Data). The user can be offered more information and attributes of the kinds of consumers (age/sex/annual income) who may visit various locations or retailers. Within a consumer location category (Coffee retail), a list of subcategories or specific retailers (Diedrich Coffee, It's a Grind, Starbucks Coffee) may be displayed hierarchically. The subcategory options maybe optionally displayed or expanded on the interface by pressing a (+) button or collapsed by pressing a (−) button as with most common user interfaces. Furthermore, each subcategory may further provide the number of locations or stores where a display device is installed (Starbuck Coffee (3)) and allow the user to pinpoint down to and target a particular display device (identified with a unique ID number) or store. Accordingly, advertising may be optionally targeted at all Coffee retail shops within the DOHN(s), or just a particular coffee retail chain (Starbucks coffee), or just a particular display device or store within the retail chain (Westwood, Calif.), which could alternatively have more than one display device. Moreover, the pricing for each of these advertising options may vary according to numerous factors including how many display devices are selected, and where the display devices are physically located (advertising over display devices at locations in Beverly Hills may cost more than El Segundo locations, for example). The user or advertiser can therefore create and run an ad campaign that fits within a certain budget that covers only certain consumer locations that reach the customers of interest on a panel by panel (or display device) basis. The same type of targeted advertising can be accomplished for other retail markets such as Health clubs, Office Lobbies and Shopping malls etc. It shall be further understood that any type or number of consumer location categories and subcategories may be created other than those expressly shown in the figures provided in accordance with this aspect of the invention.

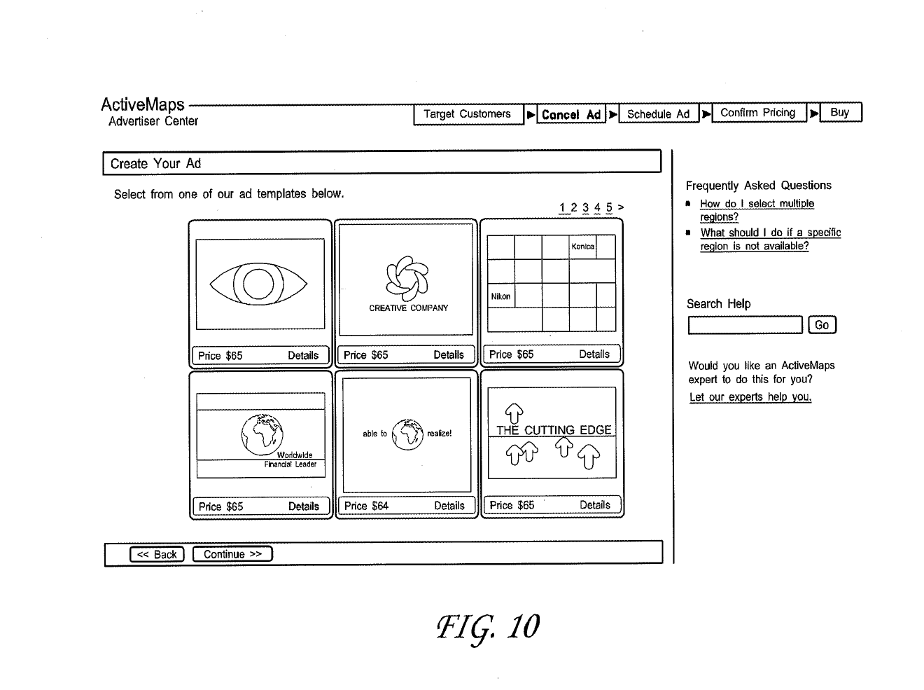

When creating an advertisement, as shown in FIG. 10, a user may be presented with a selection of choices from a predetermined list of advertising templates displayed across a series of pages over the user interface. The user may flip through the pages of templates by clicking-on page links or pressing back/continue buttons as is known in the field. The price for each advertisement template can be displayed along with further related details. Alternatively, the user may create a new advertisement or content to be uploaded through the user interface. An optional pop-up window can be provided that allows the user to Browse through available directories or access the desktop of the personal computer on which the Web browser is operating. A remotely stored file can then be therefore uploaded to the advertisement center through the user interface in accordance with this embodiment of the invention.

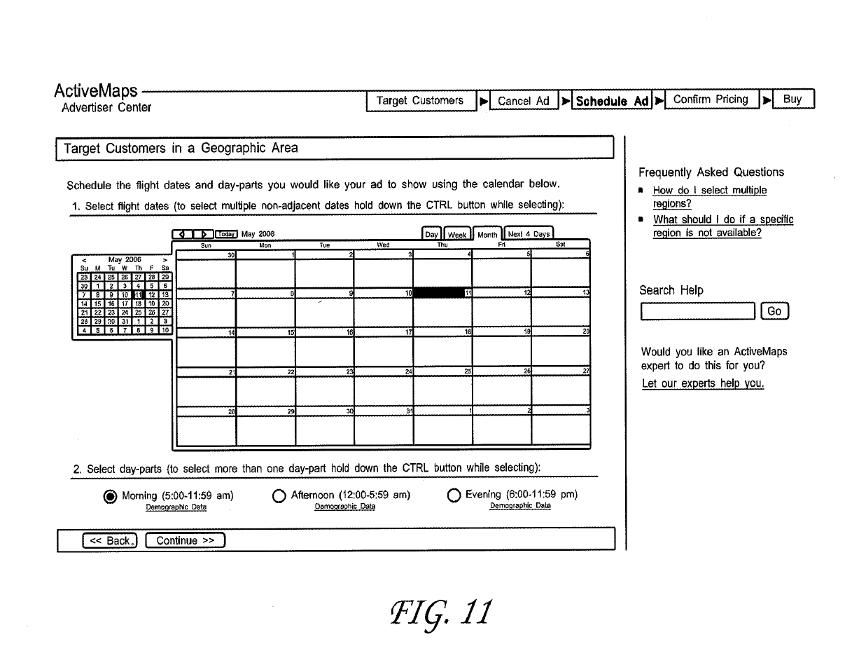

When scheduling the selected advertising for display, the user interface may next present a screen (Schedule Your Ad) that allows the user or advertiser to set the desired flight dates and portions of a day (day-parts). Various time periods may be created and displayed on schedule screen depending on how long an ad campaign may run (day, week, month, next 4 days). As shown in FIG. 11, the user may first select one or more flight dates by clicking-on particular days or series of days (by holding down CTRL button while selecting). In a second step, the user may select one or more day-parts which can be broken down into different predefined times of the day (morning 5 a-1159 a, afternoon 12:00 p-5:59 p, evening 6:00 p-1159 p). For each day-part, additional demographic data may be available to a user to explain more about the consumers for the selected location(s) at which advertisements will be targeted. For example, younger adults or teenagers may be reached more often during morning or afternoon day-parts while older adults may be targeted by scheduling advertisements during later parts of the day or evenings. As with other targeting factors described herein, the frequency in which created advertisements are run, and during which day-parts, will often affect the pricing for such advertising. More frequently run advertisements during peak business hours for certain locations may be charged a premium, while scheduling them less often and/or during of-peak hours will likely result in lower pricing. Accordingly, a user may schedule and target advertisements with the user interfaces and methods provided herein to run ad campaigns that can be created and modified in real-time to fit any desired budget independently and remotely over the Internet within Web browser environment.

The present invention has been described above with reference to various exemplary embodiments. However, those skilled in the art will recognize that changes and modifications may be made to the exemplary embodiments without departing from the scope of the present invention. For example, the various operational steps, as well as the components for carrying out the operational steps, may be implemented in alternate ways depending upon the particular application or in consideration of any number of cost functions associated with the operation of the system, e.g., various of the component and methodologies and/or steps may be deleted, modified, or combined with other components, methodologies and/or steps. For example, various of the systems and devices, such as within the global scheduling system or the regional content delivery system, can suitably utilize compression algorithms to reduce network usage and/or include failure recovery mechanisms to efficiently transfer large files that are susceptible to cellular connection interruptions. Further, it should be noted that while the method and system for media content distribution for digital out-of-home networks and applications is described above is suitable for programming and use by a user proximate the RDUs, the system can also be accessed remotely, i.e., the user can operate through a remote display having information transmitted in various manners of communication, such as by satellite/wireless or by wired connections such as IP or digital cable networks and the like. These and other changes or modifications are intended to be included within the scope of the present invention, as set forth in the following claims.

What is claimed is:

1. A method of determining content to be displayed on multiple portions of a display screen, the method comprising:
defining a plurality of media objects, each having display content;
selecting first media objects to display in a first portion of the display device according to a playlist; and
selecting at least one second media object to display in a second portion of the display device based at least in part on the display content of the first media object.

2. The method of claim 1, wherein the first portion comprises a primary region of the display device and the second portion comprises a less significant region of the display device.

3. The method of claim 1, further comprising the steps of:
receiving a user input indicating a subset of the media objects to be grouped; and
grouping the subset of the media objects in a first group;
wherein the step of selecting the at least one second media object comprises determining whether the first media object is a member of the first group and selecting the second media object from the remaining media objects in the first group.

4. The method of claim 1, wherein the first portion corresponds to video content and the second portion corresponds to scrolling informational content.

5. The method of claim 1, further comprising transmitting instructions to a remote display unit, the instructions configured to induce the remote display unit to display at least a third one of the media objects.

6. The method of claim 5, wherein the third media object is related to the first media object.

7. The method of claim 1, further comprising the steps of:
storing display data indicating that the display unit has displayed the first and second media objects; and
generating a report from the display data, wherein the report comprises a report based upon the number of times that the first media object has been displayed and a monetary value associated with the display device location and time.

8. The method of claim 1, further comprising transmitting the first and second media objects to the display device according to a schedule such that the first and second media objects are transmitted before a possible playtime indicated in the schedule.

9. The method of claim 8, further comprising the steps of:
determining whether there is space available in a memory of the display device before transmitting the plurality of media objects; and
waiting until there is space available in the memory of the display device when it is determined that there is not space available.

10. A computer implemented interface for providing and scheduling media content comprising for a multiple display media system:
a location database having data corresponding to the geographic locations of a plurality of display units;
a scheduling database having data indicating scheduled times to display media objects;
a first electronic page stored on a server, the first electronic page configured to receive address data indicating an addressed location, determine a plurality of display units located within a predetermined distance of the addressed location based on the data stored in the location database, display a representation of at least one display unit determined to be within the predetermined distance, and receive a selection of at least one of the plurality of display units indicated;
a second electronic page stored on the server, the second electronic page configured to access the scheduling database and determine times available for display of content at the selected at least one display unit, display the available times, and to receive instructions to display a media object on the at least one selected display unit at a selected time during the available times.

11. The computer implemented interface of claim 10, further comprising:
a demographic database comprising demographic data associated with the geographic locations of the plurality of display units;
wherein the first electronic page is configured to display the demographic data associated with the at least one display unit determined to be within the predetermined distance.

12. The computer implemented interface of claim 11, wherein the first electronic page is further configured to filter the at least one display unit determined to be within the predetermined distance based on the demographic data in response to an instruction to match the display units to a user selected criteria, and to prevent the display of the representation of those display units that do not match the user selected criteria.

13. The computer implemented interface of claim 12, wherein the representation of the at least one display unit within the predetermined distance comprises a map having a marker corresponding to the addressed location and at least one indicator of the geographic locations of the at least one display unit within the predetermined distance.

14. The computer implemented interface of claim 10, further comprising:
a demographic database comprising demographic data associated with the geographic locations of the plurality of display units;
wherein the second electronic page is configured to display the demographic data associated with the at least one selected display unit.

15. The computer implemented interface of claim 14, wherein the second electronic page further configured to determine a price for displaying the new media object based at least in part upon the demographic data.

16. The computer implemented interface of claim 10, wherein the second electronic page is further configured to update the scheduling database based on the instruction to display the new media object.

17. A computer implemented method for generating advertising content, the method comprising the steps of:
providing a template database comprising a plurality of media file templates;
inducing the display of a representation of at least one of the media file templates on a display screen;
receiving a user selection of one of the media file templates;
accepting edits to the selected media file template in order to generate a user media advertisement; and
storing the user media advertisement in an advertisement database.

18. The computer implemented method of claim 17, wherein the media file templates comprise at least one type of media selected from static images, video, interactive content, and audio.

19. The computer implemented method of claim 17, wherein the representation of the media file templates comprises at least one of a text list, a thumbnail image, and embedded video.

20. The computer implemented method of claim 17, wherein the representation of the media file templates includes a price associated the media file templates.

21. The computer implemented method of claim 17, wherein the edits comprise providing at least one of text, video, audio, static images, and color selections.

22. The computer implemented method of claim 17, further comprising providing the user media advertisement to at least one remote display unit according to a predetermined schedule.
